(19) United States
(12) Patent Application Publication
(10) Pub. No.: US 2011/0188893 A1
(43) Pub. Date: Aug. 4, 2011

(54) Optical writing device and image forming apparatus

(75) Inventors: Takeshi Iwasaki, Saitama (JP); Kenji Takayama, Saitama (JP); Shinichi Kojima, Saitama (JP)

(73) Assignee: Ricoh Company, Ltd., Tokyo (JP)

(21) Appl. No.: 12/929,495

(22) Filed: Jan. 28, 2011

(30) Foreign Application Priority Data
Feb. 1, 2010 (JP) 2010-020764

(51) Int. Cl. G03G 15/04

(52) U.S. Cl. 399/220

(57) ABSTRACT

Disclosed is an optical writing device including a light-emitting element array unit having a light-emitting element array in which plural light-emitting elements are mounted on a substrate member in lines in a main scanning direction, an image focusing lens forming light from the light-emitting array into an image on a writing surface, and a housing holding the light-emitting element array and the image focusing lens; and a base member having plural of the light-emitting array units arranged and held thereon zigzag in the main scanning direction. Each of the plural light-emitting array units fixes its substrate member and housing at one position. Each of the plural light-emitting array units holds the housing on the base member at a position such that moving amount differences between the substrate member, the housing, and the base member due to their thermal expansions are cancelled at adjacent joints of the plural light-emitting array units.

### BACKGROUND OF THE INVENTION

1. Field of the Invention

The present invention generally relates to image forming apparatuses, and more specifically, to an optical writing device having plural light-emitting element array units arranged zigzag and an image forming apparatus having the optical writing device.

2. Description of the Related Art

A known image forming apparatus has an optical writing device in which plural light-emitting element array units are arranged zigzag, i.e., the ends of adjacent units are arranged zigzag so as to be partially overlapped with each other in a main scanning direction. Thus, using plural inexpensive light-emitting array units having a small width such as A4 or A3 makes it possible to reduce cost for manufacturing the optical writing device compared with using one light-emitting array unit having a large width. However, this requires adjusting a mechanical arrangement between the respective units, and is prone to cause positional deviations between the joints of the adjacent units due to thermal expansions or the like, which results in the occurrence of abnormality such as black stripes and white stripes. Further, in an image reading apparatus having plural image sensors arranged zigzag, missing image information and double reading are likely to occur.

In order to address the above problems, “Patent Document 1,” for example, discloses a technology of forming fitting parts in the housings of image sensors similar in shape and connecting the image sensors to each other so as to facilitate a positioning operation at the joints of the respective sensors. Further, “Patent Document 2,” for example, discloses a technology of holding the housing member of an image sensor at the same linear expansion coefficient as the linear expansion coefficient of a retention frame so as to prevent deformation due to thermal expansions when the image sensor is fixed to the retention frame. Further, “Patent Document 3,” for example, discloses a technology of providing temperature sensors that detect temperatures near light-emitting element array units and correcting the light-emitting amounts of the light-emitting element arrays positioned at joints corresponding to temperature changes so as to prevent the occurrence of abnormal images at the joints. Further, each of “Patent Document 4,” “Patent Document 5,” “Patent Document 6,” “Patent Document 7,” and “Patent Document 8,” for example, discloses a technology of connecting the mount substrates of adjacent light-emitting element arrays or image sensors to each other with connecting members.

Meanwhile, the technology disclosed in “Patent Document 1” does not allow for positional deviations between the joints due to thermal expansions. Further, since the technology disclosed in “Patent Document 2” does not allow for the linear expansion coefficient of a mount substrate where plural image sensors are arranged zigzag, positional deviations occur in the joints of the image sensors due to thermal expansions. Further, the technology disclosed in “Patent Document 3” is low in precision because there occur errors between dimensional changes due to the actual temperatures of the light-emitting array units and the outputs of the temperature sensors, and increases cost because the temperature sensors and a control unit are required. Further, since the technologies disclosed in “Patent Document 4” through “Patent Document 8” are required to fix the connecting members to the mount substrate according to methods such as bonding and screwing, the substrate may be damaged.

Patent Document 1: JP-A-2004-336201

Patent Document 2: JP-A-2003-87504

Patent Document 3: JP-A-2003-72146

Patent Document 4: JP-B-3784249

Patent Document 5: JP-B-2572307

Patent Document 6: JP-A-5-336301

Patent Document 7: JP-A-2005-198254

Patent Document 8: JP-A-2008-11230

### SUMMARY OF THE INVENTION

The present invention may have an object of providing an optical writing device, which is capable of solving the above problems and reducing positional deviations between the joints of light-emitting element array units in a main scanning direction due to thermal expansions according to a simple configuration without damaging a substrate, and providing an image forming apparatus having the optical writing device.

According to an embodiment of the present invention, there is provided an optical writing device including a light-emitting element array unit that has a light-emitting element array in which plural light-emitting elements are mounted on a substrate member in lines in a main scanning direction, an image focusing lens that forms light from the light-emitting array into an image on a writing surface, and a housing that holds the light-emitting element array and the image focusing lens; and a base member that has plural of the light-emitting array units arranged and held thereon zigzag in the main scanning direction. Each of the plural light-emitting array units is configured to fix the corresponding substrate member and the corresponding housing thereof at one position. Each of the plural light-emitting array units holds the housing on the base member at a position such that moving amount differences between the substrate member, the housing, and the base member deformed and moved in the main scanning direction due to thermal expansions thereof are cancelled at adjacent joints of the plural light-emitting array units.

Other objects, features and advantages of the present invention will become more apparent from the following detailed description when read in conjunction with the accompanying drawings.

### BRIEF DESCRIPTION OF THE DRAWINGS

FIG. 1 is a schematic side view of an image forming apparatus to which an embodiment of the present invention is applicable;

FIG. 2 is a schematic view for explaining an image forming unit of the image forming apparatus used in the embodiment of the present invention;

FIG. 3 is a schematic view showing an optical writing device used in the embodiment of the present invention;

FIG. 4 is a schematic view showing a light-emitting element array unit used in the embodiment of the present invention;

FIG. 5 is a schematic view for explaining the zigzag arrangement of the light-emitting array units used in the embodiment of the present invention;

FIG. 6 is another schematic view for explaining the zigzag arrangement of the light-emitting array units used in the embodiment of the present invention;

FIG. 7 is a schematic view for explaining the zigzag arrangement of the light-emitting array units according to a first embodiment of the present invention; and

FIG. 8 is a schematic view for explaining the zigzag arrangement of the light-emitting array units according to a second embodiment of the present invention.

### DETAILED DESCRIPTION OF THE PREFERRED EMBODIMENTS

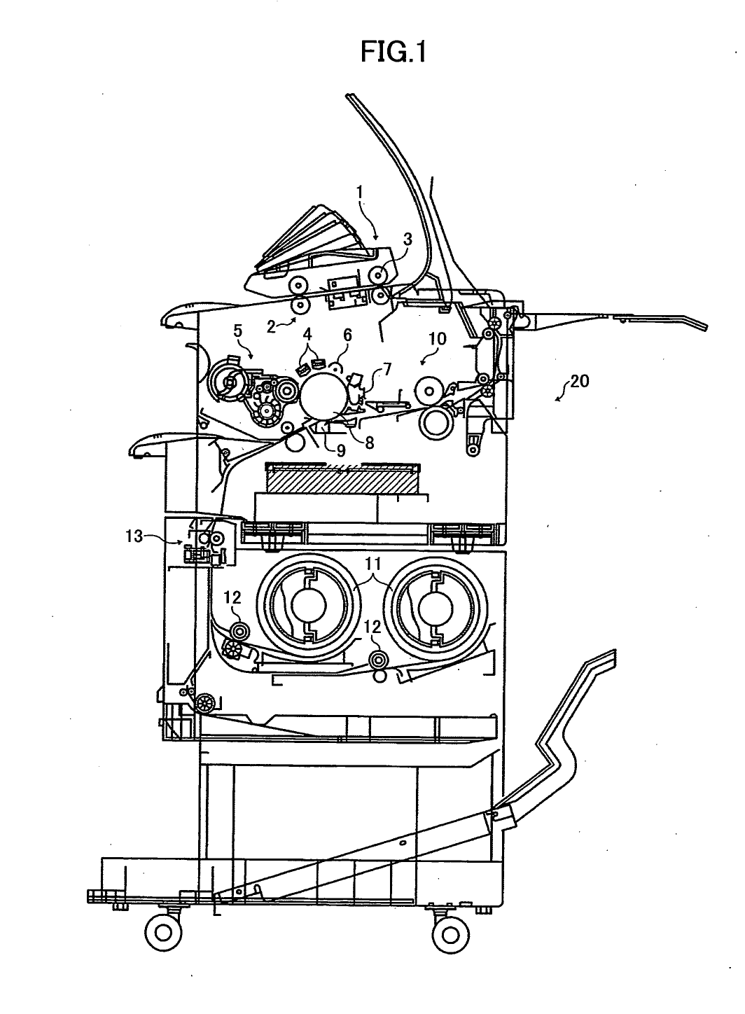

FIG. 1 shows a digital copier as an image forming apparatus to which an embodiment of the present invention is applicable. In FIG. 1, the digital copier 20 has an image scanner 1 at its upper part and a roll sheet feeding unit at its lower part. The image scanner 1 scans an image on a document while conveying the document with two document conveying rollers 2 and 3. The roll sheet feeding unit stores roll sheets 11. The roll sheets 11 are fed by sheet feeding rollers 12, cut into a predetermined length by a cutting part 13, and fed to an image forming part.

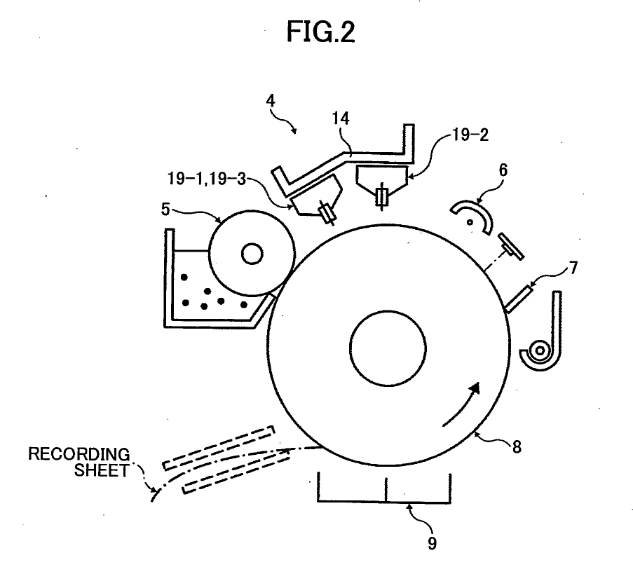

The image forming part is disposed inside an apparatus main body and below the image scanner 1. As shown in FIG. 2, the image forming part has a photosensitive drum 8; a charging unit 6 that uniformly charges the front surface of the photosensitive drum 8; an optical writing device 4 that forms an electrostatic latent image on the front surface of the charged photosensitive drum 8; a developing unit 5 that supplies toner to the electrostatic latent image on the photosensitive drum 8 so as to be visualized; a transferring unit 9 that transfers a toner image on the photosensitive drum 8 to a recording sheet; a cleaning unit 7 that cleans the front surface of the photosensitive drum 8 from which the toner image has been transferred; a fixing unit 10 that fixes a toner image transferred to a recording sheet; and the like.

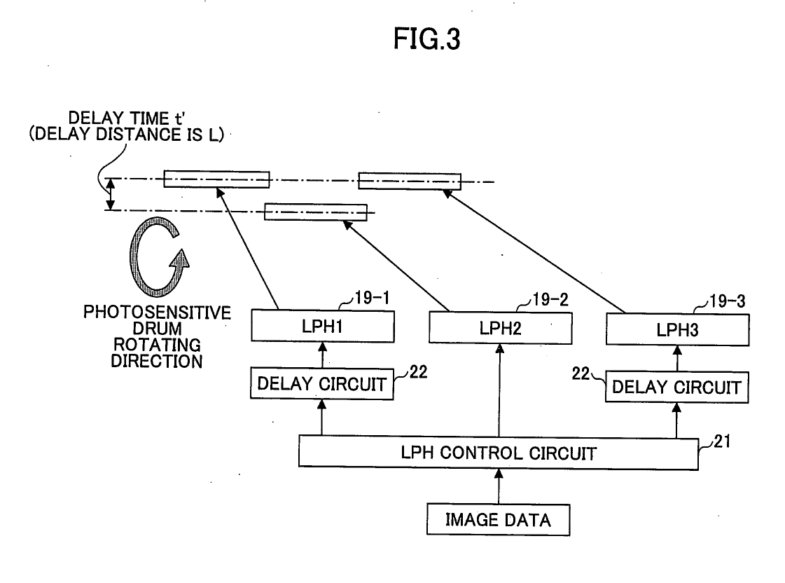

Here, a description is made of the optical writing device 4 as a feature of the embodiment of the present invention. As shown in FIGS. 2 and 3, in the optical writing device 4, three A3-sized LED print heads (hereinafter referred to as LPHs) using LEDs, which are typical light-emitting element arrays, as light-emitting element array units are arranged and held zigzag on a base member 14 in the main scanning direction of the photosensitive drum 8. The optical writing device 4 writes an image equivalent to an A0 size in a three-way split. As specifically shown in FIG. 3, an output image signal (image data) is transferred to an LPH control circuit 21 so as to be divided into three segments in a width direction. The data of the divided image signals are transferred in parallel to an LPH 19-1, an LPH 19-2, and an LPH 19-3. However, the transferring of the data to the LPH 19-1 and the LPH 19-3 is delayed for a predetermined time by delay circuits 22 so that the signals are synthesized into a single line again on the photosensitive drum 8.

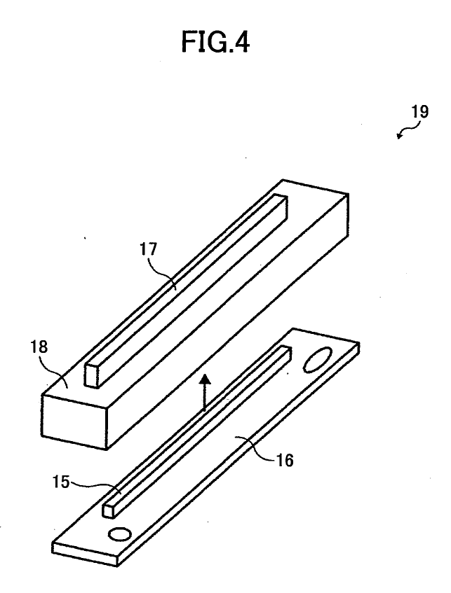

As shown in FIG. 4, the LPH 19 has a light-emitting element array 15 in which LED chips serving as light-emitting elements that expose and form an electrostatic latent image on the photosensitive drum 8 so as to correspond to an image signal are arranged on a mount substrate 16 serving as a substrate member in plural lines in the main scanning direction; a SELFOC lens 17 serving as an image focusing lens that forms light from an LED into an image on the photosensitive drum 8; and a housing 18 that holds the light-emitting array 15 and the SELFOC lens 17. Here, if the plural LPHs 19 are simply arranged zigzag on the base member 14, the base member 14, the mount substrate 16, and the housing 18 are deformed and moved due to environmental changes and temperature changes inside the optical writing device 4 because the respective members are different from each other in their linear expansion coefficients. Consequently, positional deviations occur between joints for scanning of the respective LPHs 19 in the main scanning direction. Since the positional deviations are directly converted into a latent image on the photosensitive drum 8, abnormality such as black stripes and white stripes occurs in an image formed on a recording sheet, which results in the degradation of the image.

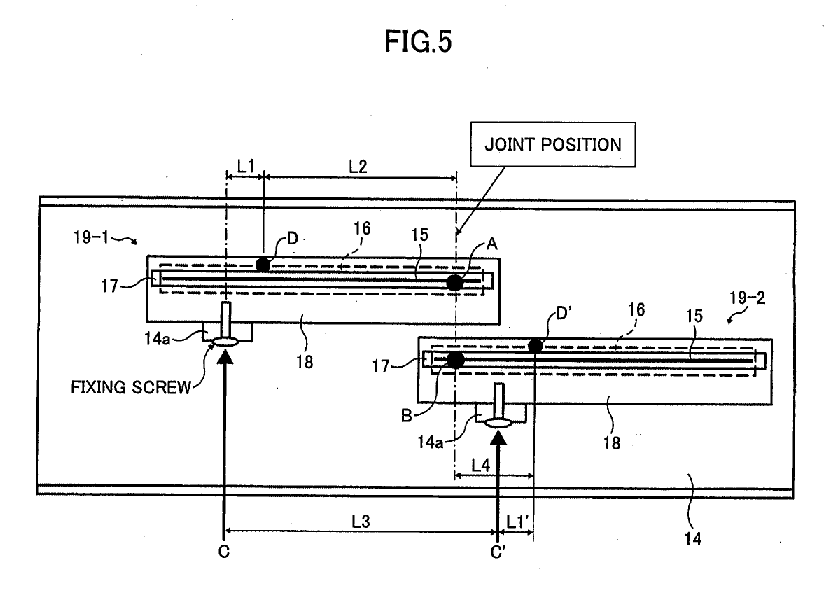

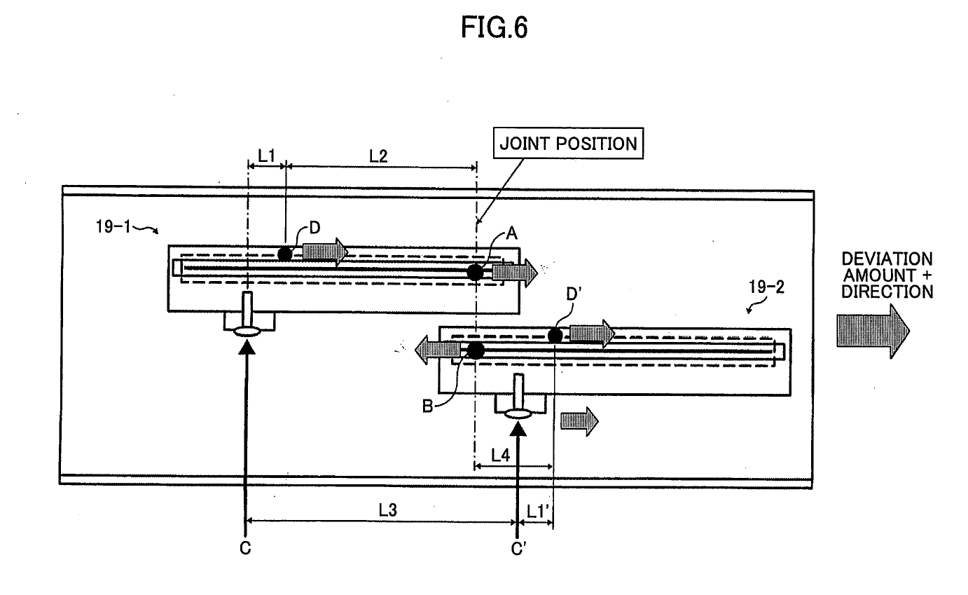

Referring to FIGS. 5 and 6, a description is now made of a method for preventing the occurrence of the above problem. First, the linear expansion coefficient S1 of a material forming the base member 14 and the linear expansion coefficient S2 of the material forming the mount substrates 16 of the LPH 19-1 and the LPH 19-2 are configured to be made the same. Then, the housings 18 and the mount substrates 16 are fixed at first corresponding positions in the main scanning direction as denoted by numerals D and D′ in FIG. 5. In addition, the housings 18 of the LPH 19-1 and the LPH 19-2 are fixed by screwing or bonding to LPH holding parts 14a provided projecting from the base member 14, whereby the LPH 19-1 and the LPH 19-2 are held zigzag on the base member 14. At this time, positions at which the housings 18 of the LPH 19-1 and the LPH 19-2 are fixed to the base member 14 are set as C and C′, respectively, and a length L1 between the set positions C and D and a length L1′ between the set positions C′ and D′ are made the same.

In FIG. 6, the joint position A of the LPH 19-1 and the joint position B of the LPH 19-2 move in the main scanning direction due to the thermal expansions of the respective members forming the LPH 19-1 and the LPH 19-2. Assuming that the moving amount of the LPH 19-1 is ΔA and the moving amount of the LPH 19-2 is ΔB, if the moving amounts ΔA and ΔB and the moving directions of the joint positions A and B are different from each other, a positional deviation occurs between the joint positions A and B, which results in the occurrence of the above problem.

Here, assuming that a right direction in FIG. 6 in which the joint positions A and B move is a (+) positive direction, the linear expansion coefficient of the respective housings 18 is S3, and the temperature rising amounts thereof are Δt, the moving amount ΔA1 of the housing 18 of the LPH 19-1 due to its thermal expansion is equivalent to the moving amount of a point D when a point C is set as a start point. That is, in FIG. 6, the point D moves in the + direction by an amount corresponding to L1×S3×Δt. The moving amount ΔA2 of the mount substrate 16 of the LPH 19-1 due to its thermal expansion is equivalent to the moving amount of a point A when the point D is set as a start point. That is, in FIG. 6, the point A moves in the + direction by an amount corresponding to L2×S2×Δt. Since the point D is the position at which the mount substrate 16 and the housing 18 are fixed, the mount substrate 16 also moves by the moving amount ΔA1. Therefore, the moving amount ΔA of the joint position A of the LPH 19-1 is calculated according to the formula ΔA=ΔA1+ΔA2=L1×S3×Δt+L2×S2×Δt.

Next, the moving amount ΔB1 of the housing 18 of the LPH 19-2 due to its thermal expansion is equivalent to the moving amount of a point D′ when a point C′ is set as a start point. That is, in FIG. 6, the point D′ moves in the + direction by an amount corresponding to L1′×S3×Δt. The moving amount ΔB2 of the mount substrate 16 of the LPH 19-2 due to its thermal expansion is equivalent to the moving amount of a point B when the point D′ is set as a start point. That is, in FIG. 6, the point B moves in a − (negative) direction by an amount corresponding to −(L4×S2×Δt). The moving amount ΔB3 of the base member 14 due to its thermal expansion is equivalent to the moving amount of the point C′ when the point C is set as a start point. That is, in FIG. 6, the point C′ moves in the + direction by an amount corresponding to L3×S1×Δt. Similar to the case of ΔA, the moving amount ΔB of the joint position B of the LPH 19-2 is calculated according to the formula ΔB=ΔB1+ΔB2+ΔB3=L1′×S3×Δt−L4×S2×Δt+L3×S1×Δt. Here, the relationship L2=L3−L4 is established according to the relationships L1+L2+L4=L3+L1′ and L1=L1′. Further, the relationship ΔA=ΔB is established according to the relationship S1≈S2. Accordingly, a deviation hardly occurs between the joint positions A and B of the LPH 19-2 and the LPH 19-2 due to the thermal expansions of the respective members, and thus an excellent image can be obtained.

According to the above configuration, (1) the linear expansion coefficient S1 of the base member 14 and the linear expansion coefficient S2 of the mount substrates 16 are made the same, (2) the mount substrates 16 and the housings 18 are fixed at the first corresponding positions in the main scanning direction; the position at which the housing 18 and the mount substrate 16 of the LPH 19-1 are fixed is denoted by the numeral D and the position at which the housing 18 and the mount substrate 16 of the LPH 19-2 are fixed is denoted by the numeral D′ as shown in FIG. 5, and (3) the position at which the housing 18 of the LPH 19-1 is held on the base member 14 is denoted by the numeral C and the position at which the housing 18 of the LPH 19-2 is held on the base member 14 is denoted by the numeral C′, and the relationship L1=L1′ is established with the length between the position C and position D set as L1 and the length between the position C′ and the position D′ set as L1′. Thus, the moving amounts of the joint positions A and B of the LPH 19-1 and the LPH 19-2 due to the thermal expansions of the respective members are made the same regardless of a positional relationship between the LPH 19-1 and the LPH 19-2, thereby preventing the occurrence of abnormal images without causing a deviation between the joints of the LPH 19-1 and the LPH 19-2.

However, in the case of meeting the condition (1) in which the linear expansion coefficient S1 of the base member 14 and the linear expansion coefficient S2 of the mount substrates 16 are made the same in the above configuration, no consideration is given to a case in which general-purpose light-emitting element arrays are particularly connected to each other when being used. Therefore, a common glass epoxy material is used as the mount substrates 16, and it is difficult for the base member 14 to be formed of a material meeting such a condition. Where the base member 14 is formed of a common ferrous material and the housings 18 are formed of an aluminum material, the linear expansion coefficient of the glass epoxy material is 13 through 16×10⁻⁶/° C., the linear expansion coefficient of the ferrous material is 11.7×10⁻⁶/° C., and the linear expansion coefficient of the aluminum material is 21×10⁻⁶/° C. If the relationships L1=L1′=10 mm, L2=280 mm, L3=300 mm, and L4=20 mm are established assuming a temperature increase of 20° C. and the LPH having a width of A3, a maximum positional deviation of about 25.8 μm occurs in the right direction in FIG. 6 between the LPH 19-1 and the LPH 19-2 in the main scanning direction in such a manner that the joint position A of the LPH 19-1 overlaps the joint position B of the LPH 19-2. Where the density of pixels is 600 dpi, a positional deviation corresponding to about a half pixel occurs relative to a pixel pitch of 42.3 μm. Therefore, pixels are overlapped with each other and an abnormality such as black stripes occurs, which results in the degradation of image quality. In view of this, a description is now made of a configuration capable of preventing the occurrence of the problem even if the linear expansion coefficient S1 of the base member 14 and the linear expansion coefficients S2 of the mount substrates 16 are different from each other.

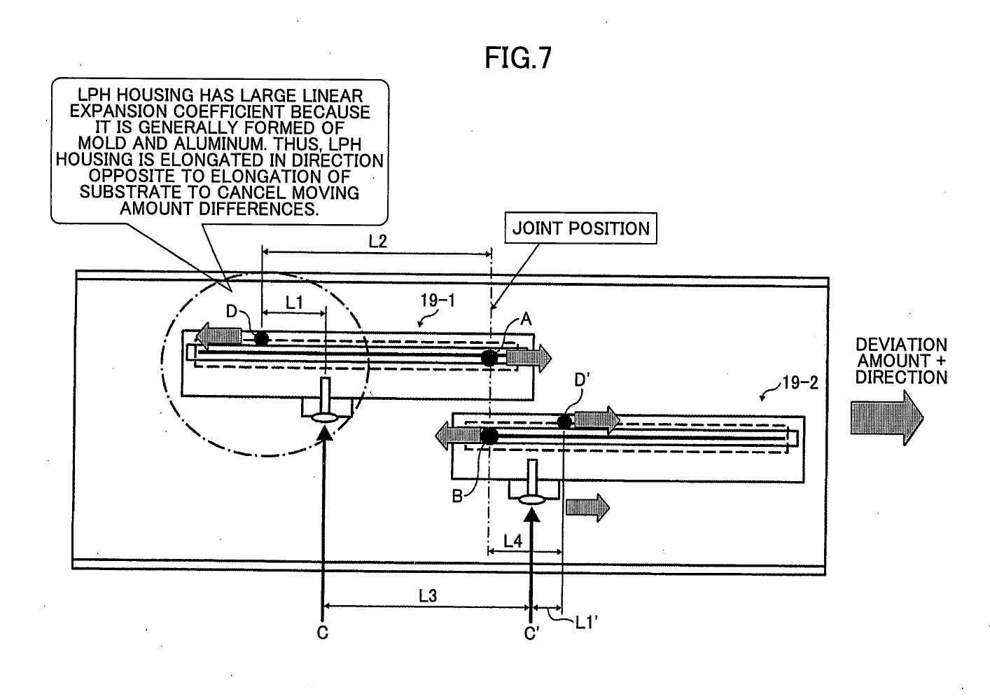

As shown in FIG. 7, compared with the arrangement of the LPH 19-1 shown in FIG. 6, the position C at which the LPH 19-1 is held on the base member 14 is set on the right side of the position D at which the housing 18 and the mount substrate 16 of the LPH 19-1 are fixed. Accordingly, the point D moves in one direction by an amount corresponding to L1×S3×Δt on the left side in FIG. 7 opposite to the moving direction of the joint position A when the mount substrate 16 of the LPH 19-1 is deformed and moved due to its thermal expansion. Therefore, where the length L1 between the position C and the position D is set such that the moving amounts of the joint position A and the joint position B due to the thermal expansions are made the same, the occurrence of a positional deviation between the joint positions in the main scanning direction can be reduced even if the linear expansion coefficients S1 and S2 of the mount substrates 16 and the base members 14 are different from each other. Further, if the linear expansion coefficient S3 of the housings 18 is set to be greater than the linear expansion coefficients S1 and S2 of the mount substrates 16 and the base member (S3>S2>S1), the length L1 between the point C and the point D can be made relatively small. Therefore, the degree of freedom in the arrangement of the plural LPHs 19 increases.

Here, the length L1 between the point C and the point D is considered. Assuming that the moving direction of the respective positions in a right direction in FIG. 7 is a (+) positive direction, the linear expansion coefficient of the respective housings 18 of the LPH 19-1 and the LPH 19-2 is S3, and the temperature rising amount thereof is Δt, the moving amount ΔA1 of the housing 18 of the LPH 19-1 due to its thermal expansion is equivalent to the moving amount of the point D when the point C is set as a start point. That is, in FIG. 7, the point D moves in the − direction by an amount corresponding to L1×S3×Δt. The moving amount ΔA2 of the mount substrate 16 of the LPH 19-1 due to its thermal expansion is equivalent to the moving amount of the point A when the point D is set as a start point. That is, the point A moves in the + direction by an amount corresponding to L2×S2×Δt in FIG. 7. Since the point D is the position at which the mount substrate 16 and the housing 18 are fixed, the mount substrate 16 also moves by the moving amount ΔA1. Therefore, the moving amount ΔA1 of the joint position A is calculated according to the formula ΔA=ΔA1+ΔA2=−L1×S3×Δt+L2×S2×Δt.

Next, the moving amount ΔB1 of the housing 18 of the LPH 19-2 due to its thermal expansion is equivalent to the moving amount of the point D′ when the point C′ is set as a start point. That is, in FIG. 7, the point D′ moves in the + direction by an amount corresponding to L1′×S3×Δt. The moving amount ΔB2 of the mount substrate 16 of the LPH 19-2 due to its thermal expansion is equivalent to the moving amount of the point B when the point D′ is set as a start point. That is, in FIG. 7, the point B moves in the − (negative) direction by an amount corresponding to −(L4×S2×Δt). The moving amount ΔB3 of the base member 14 due to its thermal expansion is equivalent to the moving amount of the point C′ when the point C is set as a start point, and the point C′ moves in the + direction by an amount corresponding to L3×S1×Δt. Similar to the case of ΔA, the moving amount ΔB of the joint position B of the LPH 19-2 is calculated according to the formula ΔB=ΔB1+ΔB2+ΔB3=L1′×S3×Δt−L4×S2×Δt+L3×S1×Δt. Here, the relationship L1={(L2+L4)×(S2−S1)−L1′×(S3−S1)}/(S3−S1) is established (S3>S1, S2) according to the relationships L2+L4=L1+L3+L1′ and L3=L1+L2−L1′+L4. L1 can be calculated if the respective linear expansion coefficients S1, S2, S3, L2, L4, and L1′ are known.

If the mount substrates 16 are formed of a common glass epoxy material (linear expansion coefficient S2=16×10⁻⁶/° C.), the base members 14 are formed of a common ferrous material (linear expansion coefficient S1=11.7×10⁻⁶/° C.), the housings 18 are formed of an aluminum material (linear expansion coefficient S3=21×10⁻⁶/° C.), and the relationships L1′=10 mm, L2=280 mm, and L4=20 mm are established in consideration of the LPH having a width of A3, the length L1 between the point C and the point D is calculated as 128.7 mm based on the above formula. If the positional relationship between the LPH 19-1 and the LPH 19-2 is set according to the above numerical values, a positional deviation between the joint position A of the LPH 19-1 and the joint position B of the LPH 19-2 due to the thermal expansions of the respective members can be reduced, which in turn makes it possible to prevent the occurrence of abnormal images.

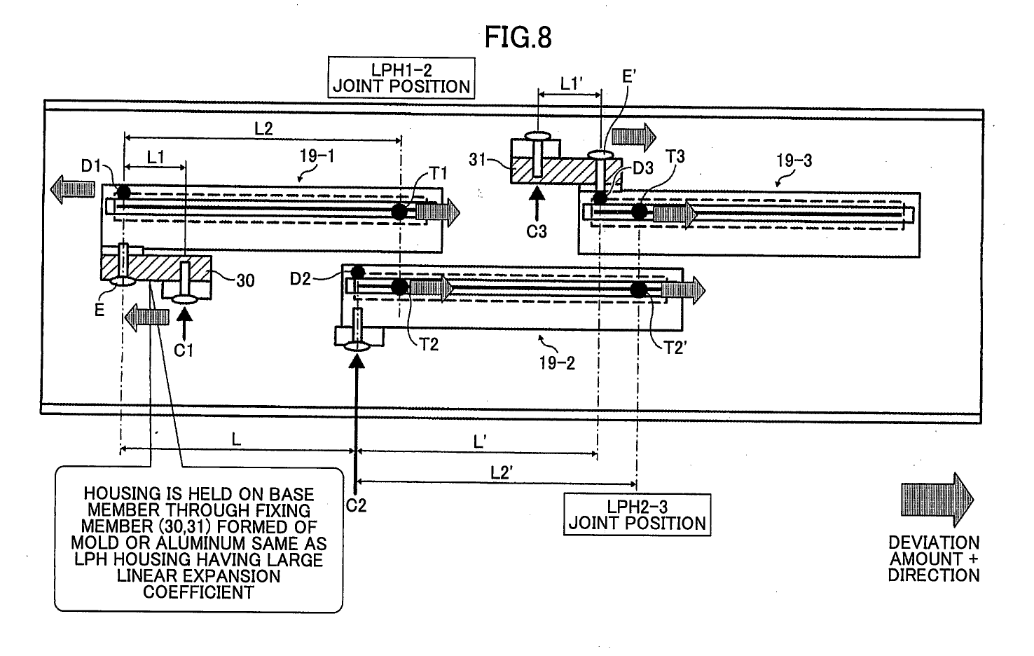

The above embodiment describes a case in which the two LPHs 19 are arranged. In the case of arranging three or more LPHs 19, however, it is necessary to increase the length L1 shown in FIG. 7 or set the elongating direction of the length L1 to be opposite in order to cancel moving amount differences in the main scanning direction between the joint positions of the adjacent LPHs 19 due to the thermal expansions. Further, cancellation of a positional deviation using the housings 18 of the LPHs 19 brings trouble. Referring to FIG. 8, a description is now made of a configuration for solving this problem.

According to the configuration shown in FIG. 8, the LPH 19-1, the LPH 19-2, and the LPH 19-3 are used as the light-emitting element array units 19. The housings 18 of the LPH 19-1 and LPH 19-3 are held on the base member 14 through fixing members 30 and 31, respectively, formed of a material having a linear expansion coefficient greater than the linear expansion coefficients S1 and S2 of the base member 14 and the mount substrates 16. The fixing members 30 and 31 are set so as to make the lengths L1 and L1′ be sufficient for canceling moving amount differences in the main scanning direction between the joint positions of the adjacent LPHs 19 due to the thermal expansions. Specifically, first, in order to reduce factors when the LPHs 19 are caused to move at the joint positions due to the thermal expansions, the position of a point D2 at which the housing 18 and the mount substrate 16 of the LPH 19-2 are fixed and the position of a point C2 at which the housing 18 of the LPH 19-2 is fixed to the base member 14 are made the same in the main scanning direction. In addition, the positions of points E and E′ at which the housings 18 of the LPH 19-1 and the LPH 19-3 are fixed to the fixing members 30 and 31, respectively, and the positions of points D1 and D3 at which the housings 18 and the mount substrates 16 of the LPH 19-1 and the LPH 19-3, respectively, are fixed, are made the same. Accordingly, influences due to the thermal expansions of the housings 18 of the LPH 19-1, the LPH 19-2, and the LPH 19-3 are eliminated.

Next, the movements of the joint position T1 of the LPH 19-1, the joint positions T2 and T2′ of the LPH 19-2, and the joint position T3 of the LPH 19-3 due to the thermal expansions are considered using the point C2, at which the housing 18 and the base member 14 of the LPH 19-2 are fixed, as a reference.

Assuming that the moving direction of the respective positions in a right direction in FIG. 8 is a (+) positive direction, the linear expansion coefficient of the fixing member 30 is S3, and the temperature rising amount thereof is Δt, the moving amount ΔW1 of the fixing member 30 due to its thermal expansion is equivalent to the moving amount of the point D1 at which the housing 18 and the mount substrate 16 of the LPH 19-1 are fixed when point C1 at which the fixing member 30 and the base member 14 are fixed is set as a start point. That is, in FIG. 8, the point D1 moves in the − direction by an amount corresponding to L1×S3×Δt. A moving amount ΔW2 due to the thermal expansion of the mount substrate 16 of the LPH 19-1 is equivalent to the moving amount of the point T1 when a point D1 is set as a start point. That is, in FIG. 8, the point T1 moves in the + direction by an amount corresponding to L2×S2×Δt. The moving amount ΔW3 of the base member 14 due to its thermal expansion is equivalent to the moving amount of the point C1 when the point C2 at which the housing 18 and the base member 14 of the LPH 19-2 are fixed is set as a start point. That is, in FIG. 8, the point C1 moves in the − direction by an amount corresponding to −(L−L1)×S1×Δt. Accordingly, the moving amount ΔW of the joint position T1 of the LPH 19-1 is calculated according to the formula ΔW=ΔW1+ΔW2+ΔW3=−L1×S3×Δt+L2×S2×Δt−(L−L1)×S1×Δt.

Next, the moving amount of the mount substrate 16 of the LPH 19-2 due to its thermal expansion is equivalent to the moving amount ΔX of the joint position T2 when the point D2 at which the housing 18 and the mount substrate 16 of the LPH 19-2 are fixed is set as a start point. That is, in FIG. 8, the position T2 moves in the + direction by an amount corresponding to (L2−L)×S2×Δt. Accordingly, if the moving amounts of the joint positions T1 and T2 are the same, no positional deviation occurs between the joint positions T1 and T2. Therefore, if the moving amounts ΔW and ΔX are made the same, the relationships ΔW=ΔX and −L1×S3×Δt+L2×S2×Δt−(L−L1)×S1×Δt=(L2−L)×S2×Δt are established. In other words, the relationship L1=L×(S2 −S1)/(S3 −S1) is established (S3>S2>S1), and the length L1 of the fixing member 30 is calculated according to this formula. Accordingly, if the linear expansion coefficients S1, S2, and S3 and the length L are known, the length L1 can be calculated.

Next, the moving amount of the mount substrate 16 of the LPH 19-2 due to its thermal expansion is equivalent to the moving amount ΔY of the joint position T2′ when the point D2 at which the housing 18 and the mount substrate 16 of the LPH 19-2 are fixed is set as a start point. That is, in FIG. 8, the position T2′ moves in the + direction by an amount corresponding to L2′×S2×Δt.

Assuming that the moving direction of the respective positions in the right direction in FIG. 8 is the (+) positive direction, the linear expansion coefficient of the fixing member 31 is S3, and the temperature rising amount thereof is Δt, the moving amount ΔZ1 of the fixing member 31 due to its thermal expansion is equivalent to the moving amount of the point D3 at which the fixing member 31 and the base member 14 are fixed when a point C3 at which the fixing member 31 and the base member 14 are fixed is set as a start point. That is, in FIG. 8, the point D3 moves in the + direction by an amount corresponding to L1′×S3×Δt. The moving amount ΔZ2 of the mount substrate 16 of the LPH 19-3 due to its thermal expansion is equivalent to the moving amount of the point T3 when the point D3 is set as a start point. That is, in FIG. 8, the point T3 moves in the + direction by an amount corresponding to (L2′−L). The moving amount ΔZ3 of the base member 14 due to its thermal expansion is equivalent to the moving amount of a point C3 when the point C2 at which the housing 18 and the base member 14 of the LPH 19-2 are fixed is set as a start point. That is, in FIG. 8, the point C3 moves in the + direction by an amount corresponding to (L′−L1′)×S1×Δt. Accordingly, the moving amount ΔZ of the joint position T3 is calculated according to the formula ΔZ=ΔZ1+ΔZ2+ΔZ3=L1′×S3×Δt+(L2′−L)×S2×Δt+(L′−L1′)×S1×Δt. Accordingly, if the moving amounts of the joint positions T2′ and T3 are the same, no positional deviation occurs between the joint positions T2′ and T3. Therefore, if the moving amounts ΔY and ΔZ are made the same, the relationships ΔY=ΔZ and L2′×S2×Δt=L1′×S3×Δt+(L2′−L)×S2×Δt+(L′−L1′)×S1×Δt are established. In other words, the relationship L1′=L′×(S2−S1)/(S3−S1) is established (S3>S2>S1), and the length L1′ of the fixing member 31 is calculated according to this formula. Accordingly, if the linear expansion coefficients S1, S2, and S3 and the length L are known, the length L1′ can be calculated. Further, if the relationship L=L′ is established, the length L1 of the fixing member 30 and the length L1′ of the fixing member 31 are the same as a matter of course.

A specific example is described below. If the mount substrates 16 are formed of a common glass epoxy material (linear expansion coefficient S2=16×10⁻⁶/° C.), the base member 14 is formed of a common ferrous material (linear expansion coefficient S1=11.7×10⁻⁶/° C.), the housings 18 are formed of an aluminum material (linear expansion coefficient S3=21×10⁻⁶/° C.), and the relationship L=L′=300 mm is established in consideration of the LPH having a width of A3, the lengths of the fixing members 30 and 31 are calculated as L1=L1′=138.7 mm based on the above formula. If the positional relationship between the LPH 19-1, the LPH 19-2, and the LPH 19-3 is set according to the above numerical values, a positional deviation between the joint position T1 of the LPH 19-1, the joint position T2 of the LPH 19-2, and the joint position T3 of the LPH 19-3 due to the thermal expansions of the respective members can be reduced, which in turn makes it possible to prevent the occurrence of abnormal images.

As described above, there is a degree of freedom in the settings of the lengths and the material of the fixing members 30 and 31. Therefore, with the appropriate settings of the fixing members 30 and 31, it is possible to arrange, without particularly changing the configuration for holding the general-purpose light-emitting array units, the plural light-emitting array units zigzag while preventing the occurrence of positional deviations between the joints of the light-emitting array units due to the thermal expansions.

According to the embodiments of the present invention, even if the linear expansion coefficients of the substrate members and the base member are different from each other, positional deviations between the joints of the light-emitting array units due to the thermal expansions of the substrate members, the housings, and the base member can be reduced, which in turn makes it possible to prevent the occurrence of abnormal images.

The present invention is not limited to the specifically disclosed embodiments, and variations and modifications may be made without departing from the scope of the present invention.

The present application is based on Japanese Priority Application No. 2010-020764 filed on Feb. 1, 2010, the entire contents of which are hereby incorporated herein by reference.

What is claimed is:

1. An optical writing device comprising:
a light-emitting element array unit that includes
a light-emitting element array in which plural light-emitting elements are mounted on a substrate member in lines in a main scanning direction,
an image focusing lens that forms light from the light-emitting array into an image on a writing surface, and
a housing that holds the light-emitting element array and the image focusing lens; and
a base member that has plural of the light-emitting array units arranged and held thereon zigzag in the main scanning direction, wherein
each of the plural light-emitting array units is configured to fix the corresponding substrate member and the corresponding housing thereof at one position, and
each of the plural light-emitting array units holds the housing on the base member at a position such that moving amount differences between the substrate member, the housing, and the base member deformed and moved in the main scanning direction due to thermal expansions thereof are cancelled at adjacent joints of the plural light-emitting array units.

2. The optical writing device according to claim 1, wherein
the housing is formed of a material having a linear expansion coefficient greater than linear expansion coefficients of a material forming the base member and a material forming the substrate member.

3. An optical writing device comprising:
a light-emitting element array unit that includes
a light-emitting element array in which plural light-emitting elements are mounted on a substrate member in lines in a main scanning direction,
an image focusing lens that forms light from the light-emitting array into an image on a writing surface, and
a housing that holds the light-emitting element array and the image focusing lens; and
a base member that has plural of the light-emitting array units arranged and held thereon zigzag in the main scanning direction, wherein
each of the plural light-emitting array units is configured to fix the substrate member and the housing thereof at one position,
each of the plural light-emitting array units has the housing held on the base member through a corresponding one of plural fixing members having a linear expansion coefficient greater than linear expansion coefficients of a material forming the base member and a material forming the substrate member, and
for each of the plural light-emitting array units, a length of the fixing member is set such that moving amount differences between the substrate member, the housing, and the base member deformed and moved in the main scanning direction due to thermal expansions thereof are cancelled at adjacent joints of the plural light-emitting array units.

4. The optical writing device according to claim 3, wherein
the plural light-emitting array units comprise three or more light-emitting array units, and
two of the plural light-emitting array units positioned one at each end are held on the base member through the corresponding fixing members.

5. An image forming apparatus having the optical writing device according to claim 1.
